(19) United States
(12) Patent Application Publication
(10) Pub. No.: US 2003/0028559 A1
(43) Pub. Date: Feb. 6, 2003

(54) Method of analyzing a document represented in a markup language

(76) Inventor: Jean-Jacques Moreau, Rennes (FR)

Correspondence Address: FITZPATRICK CELLA HARPER & SCINTO, 30 ROCKEFELLER PLAZA, NEW YORK, NY, 10112, US

(21) Appl. No.: 10/178,370

(22) Filed: Jun. 25, 2002

(30) Foreign Application Priority Data
Jun. 27, 2001 (FR) 0108475

(51) Int. Cl. G06F 17/24

(52) U.S. Cl. 707/501.1; 707/513

(57) ABSTRACT

The invention relates to a method of analyzing a document represented in a markup language comprising the following steps:

detecting (S321) a tag of predefined type, said tag being associated with at least one content length attribute;

reading (S322) the value (n) of said content length attribute; and

automatically identifying (S323) a set of data following said tag and of length equal to said read value (n).

Use in particular for processing a set of binary data incorporated verbatim in a document in XML language.

The present invention relates to a method of analyzing a document represented in a markup language.

It also relates to a method of incorporating a set of data in such a document and to a method of processing a set of data thus incorporated in a document.

The invention further relates to an analyzing device, an incorporating device and a processing device adapted respectively to implement the analyzing, incorporating and processing methods according to the invention.

In general, the invention applies to communication networks in which the exchanges between computers and other devices communicating with the network are made by means of the transfer of documents and requests presented in a markup language of XML (“eXtensible Markup Language”) type.

XML language is a markup language, that is to say a language which presents information structured by tags. It is possible to invent new tags at will to isolate all the elementary items of information which a document page may comprise.

Any textual data can thus be presented in a markup language enabling their transfer and processing on a communication network.

However, it is frequent to have to transmit, apart from these textual data, other types of data on a communication network, and in particular binary data representing for example a digital image.

This case arises in particular when a client computer requests a server computer of the network to execute a particular form of processing on the image, for example a geometrical transformation of the image.

In such a case, a request for the remote execution of a function is generated in XML language by the client station and transferred via the communication network to a server station.

However, the markup language such as the XML language does not permit data, which are not themselves encoded in XML language, such as for example binary data, to be included in a document or request in XML language.

A possible technique therefore consists in transmitting these digital data in a separate request destined for the server station. This technique leads to a supplementary delay, obliges a supplementary request to be generated at the client station and cannot be used when for example the client station only has intermittent access to the network. Such is the case in particular for a mobile telephone.

Another technique consists in encoding the binary data in ASCII, that is to say to transform these binary data into a chain of characters which can then be inserted into a document represented in a markup language. This solution is long to implement and has the supplementary drawback of considerably increasing the size of the original data to be transmitted.

It is also known to use a communication protocol such as MIME, commonly used to attach a file to an electronic mail. This technique consists of joining an XML document, for example a request for the execution of a function, end to end with associated binary data. This also presents the drawback of being complex to implement and to separate the data to be processed from the actual processing request. At the time of processing, it is necessary to entirely analyze the document in XML language before being able to access the data to be processed.

The object of the present invention is to overcome the drawbacks mentioned above and to propose a new technique for attaching a set of data of any type to a document represented in a markup language.

According to a first aspect of the invention, a method of analyzing a document represented in a markup language comprises the following steps:

detecting a tag of predefined type, said tag being associated with at least one content length attribute;

reading the value of said content length attribute; and

automatically identifying a set of data following said tag and of length equal to said read value.

By virtue of the use of a specific tag associated with a length attribute, it is possible to give a particular instruction to the parser enabling the automatic identification of a set of data, considered by the parser as a unique block of data, of particular length given by the value of the content length attribute.

By associating the length of the set of data with this tag of predefined type, it is possible for the parser to identity overall the set of data, without performing an analysis character by character which could not be correctly conducted on a non-textual set of data.

This tag of predefined type thus instructs the parser to ignore a set of data which cannot be read by a markup language document parser.

According to a preferred feature of the invention, the analyzing method further comprises a step of memorizing said set of data.

It is thus possible to memorize a set of data with a view to later processing by an application implemented after the analysis of the document.

According to a first preferred feature of the invention, the tag being associated in addition with a content type attribute, the analyzing method comprises the following steps:

reading the value of said content type attribute; and

memorizing said set of data and the value of said content type attribute.

The memorization of the type of data incorporated into the document in markup language makes it possible to indicate to the parser or a particular application the type of data with a view to their processing.

According to a second aspect of the invention, a method of incorporating a set of data in a document represented in a markup language comprises the following steps:

introducing an opening tag of predefined type, comprising at least one content length attribute;

acquiring the length of said set of data;

associating an attribute value equal to said acquired length with said content length attribute;

incorporating said set of data verbatim in the document, after said opening tag of predefined type; and

introducing a closing tag of said predefined type.

The use of a tag of predefined type, associated with a length attribute permits the inclusion, in a document of XML type, of data that are not readable by a conventional markup language document parser. The data are incorporated verbatim in the document, that is to say without prior processing liable to delay the construction of the document in markup language and to increase its size.

The introduction of the set of data is made between an opening tag and a closing tag of the markup language, respecting the structure of the markup language.

According to a preferred feature of this second aspect of the invention, the incorporating method further comprises the following steps:

determining the content type of said set of data, chosen from a predefined group of content types; and

associating said opening tag of predefined type with a content type attribute and an attribute value equal to said determined content type.

The association of the content type with the tag makes it possible, on analyzing the document later, to indicate to the parser or to a particular application the type of data to be processed.

According to a third aspect of the invention, a method of processing a set of data incorporated in a document represented in a markup language, comprises the following steps:

analyzing the document by an analyzing method according to the first aspect of the invention; and

processing the set of data in the form as identified.

The data being incorporated directly in a document in markup language, their processing can be implemented after analysis of the document, without requiring a prior transformation of the data.

According to a preferred feature of this third aspect of the invention, the set of data being a set of binary data representing a digital image, the processing method comprises a step of displaying the image at the completion of the processing of the set of binary data identified.

It is thus possible, by virtue of the invention, to display images progressively with the analysis of a document in markup language, as soon as identification has been made of a set of binary data representing that image incorporated verbatim in the document.

According to a further preferred feature of this third aspect of the invention, the document represented in a markup language being a request for the remote execution of a function on a set of data, the processing method comprises a step of executing the function on a set of data identified.

In this particularly advantageous application, the processing method makes it possible to proceed at the same time with the analysis of the request for executing a function represented in a markup language and with the identification of data on which the function must be executed.

The present invention also relates to a device for analyzing a document represented in a markup language, comprising:

means for detecting a tag of predefined type, said tag being associated with at least one content length attribute;

means for reading the value of said content length attribute; and

means for automatically identifying a set of data following said tag and of length equal to the value read.

It also relates to a device for incorporating a set of data in a document represented in a markup language, comprising:

means for introducing an opening tag of predefined type comprising at least one content length attribute;

means for acquiring the length of said set of data;

means for associating an attribute value equal to said acquired length with said content length attribute;

means for incorporating said set of data verbatim in the document, after said opening tag of predefined type; and

means for introducing a closing tag of said predefined type.

Finally it relates to a device for processing a set of data incorporated in a document represented in a markup language, comprising an analyzing device according to the invention and means for processing a set of data identified by the analyzing device.

These devices for analysis, incorporation and processing present advantages and features similar to those of the methods which they implement.

The present invention is particularly advantageous for the processing of a set of binary data, in particular representing a digital image.

It applies in particular to any document represented in XML language, and especially to a request for the remote execution of a function represented in a markup language such as the XML language.

The present invention also relates to a mobile telephone, a personal digital assistant, and more generally to any computer system comprising an analyzing device and/or an incorporating device and/or a processing device according to the invention.

It also relates to an information carrier, possibility partially or wholly removable, readable by a computer system, and containing instructions of a computer program adapted to implement an analyzing method and/or an incorporating method and/or a processing method according to the invention, when the program is loaded and run by a computer system.

Finally it concerns a computer program stored on an information carrier, said program comprising instructions adapted to implement an analyzing method and/or an incorporating method and/or a processing method according to the invention, when it is loaded and run by a computer system.

This mobile telephone, this personal digital assistant, this information system, this information carrier and this computer program present similar advantages to the methods which they implement.

Still other features and advantages of the invention will appear in the following description.

In the accompanying drawings, given by way of non-limiting example:

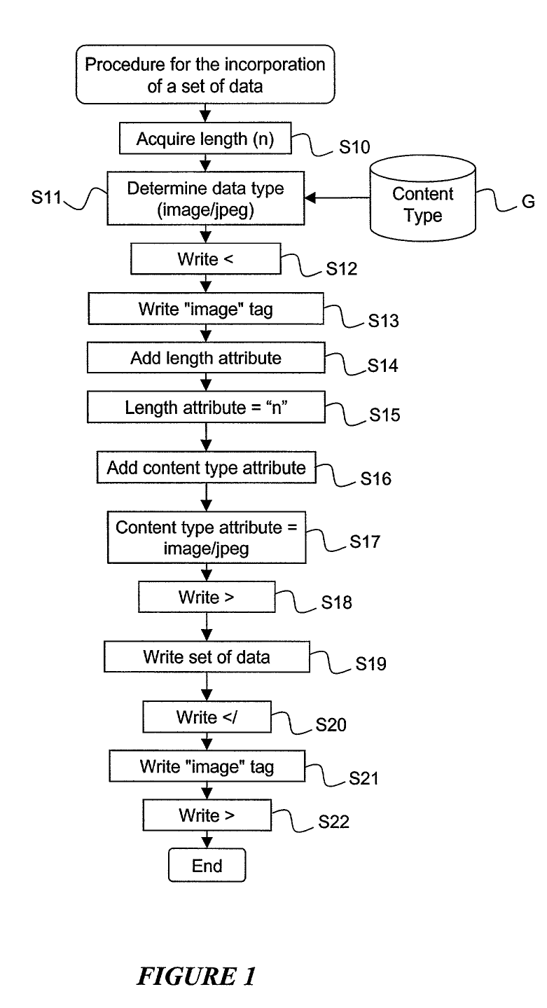

FIG. 1 is an algorithm illustrating the incorporating method according to the invention;

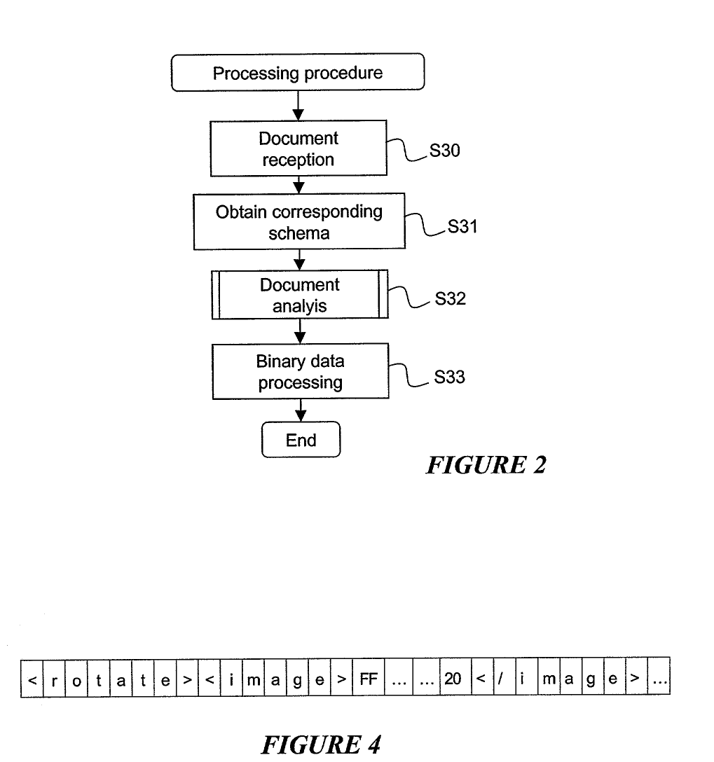

FIG. 2 is an algorithm illustrating the processing method according to the invention;

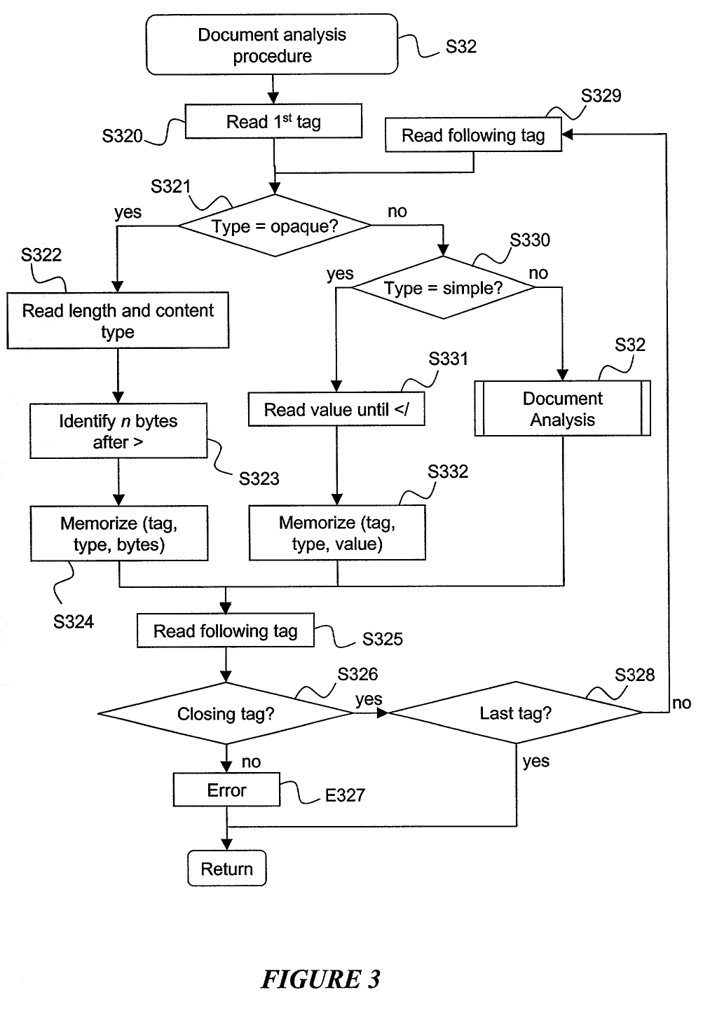

FIG. 3 is an algorithm illustrating the analyzing method according to the invention;

FIG. 4 is a table illustrating the memorization of the data at the completion of the analyzing method; and

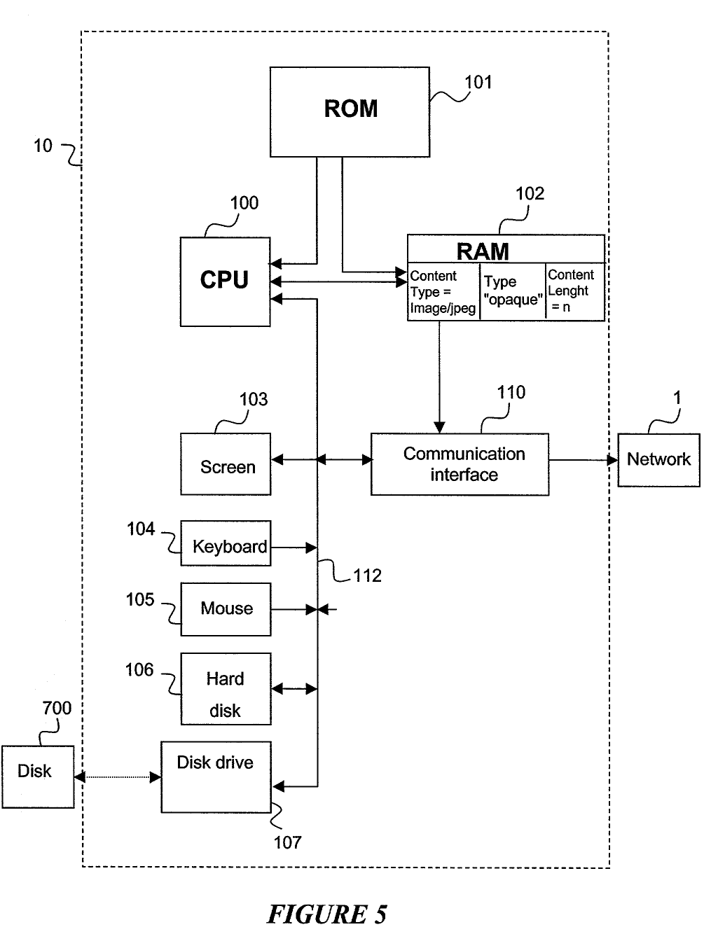

FIG. 5 illustrates schematically a computer system adapted to implement the invention.

A method of incorporating a set of data in a document represented in a markup language will be described below.

Here, and in a manner that is in no way limiting, a set of binary data representing a digital image will be considered.

This set of binary data can for example be a file of compressed data representing an image in JPEG (Joint Picture Expert Group) format.

This set of binary data is incorporated in a document in XML language.

This document in XML language can thus easily be used on a communication network.

In particular, this XML document can be a request for the execution of a function, enabling a particular processing operation to be applied to a digital image.

Reference can advantageously be made to the European patent application EP 1 065 592 describing the manner of executing a function on a digital document, and in particular the manner of executing a function remotely between computers of the same communication network.

Thus, when a client computer requests a server computer to apply a particular processing operation to an image, for example a rotation, it is necessary to transmit the image itself to the server computer in addition to the request for the execution of the rotation function.

With reference to FIG. 1 there will first of all be described below the method incorporating a set of binary data representing an image in a request for remote execution of a function written in XML language.

This incorporating method first of all comprises a step S10 of acquiring the length n of this set of binary data to be incorporated.

In the case of a file of binary data, this length n may typically be equal to the number of bytes contained in the file.

The acquisition of the length may thus be performed by reading the number of bytes memorized in the file of data to be incorporated.

A determination step S11 is next implemented in order to determine the content type of the set of data.

The content type is chosen from a group of predefined content types G.

This group of content types G may have different types of data making it possible to specify their nature. Here the content type “image/JPEG” can be chosen in the group G to characterize the set of binary data to be incorporated.

In a typical manner, the content types memorized in the group G may follow the conventions of the MIME field “Content-Type”, which is well known for qualifying files attached to electronic mail.

Apart from the “image/jpeg” type, the group of content types may also comprises the “ZIP” type.

An opening tag of predefined type is next introduced into the XML request.

This introductory step comprises more particularly a step S12 of writing an open bracket<then a step S13 of actually writing the name of the tag.

Here, by way of example, the name of the tag is “image”.

This tag is of predefined type, called the “opaque” type in the description below.

This “opaque” type may be defined in the header of the XML document or alternatively in an XML schema associated with the XML document.

This “opaque” type makes it possible to introduce data in an XML document which are not represented in a markup language of XML type.

Here we consider that the XML document in which the set of binary data is incorporated, is associated in a typical manner with an XML schema defining among others the type of tags used for the writing of such an XML document.

Thus, the image tag is defined directly in the XML schema by its type “xs:opaque”.

Alternatively, the definition of the tag may be in the header of the XML document.

A number of attributes, here two, are associated with this “image” tag.

The association and the definition of these attributes with this “image” tag may also be created in the header of the XML document.

In particular, a content length attribute “ContentLength”, of which the value is an integer, is associated with the “image” tag.

This attribute enables the length of the incorporated set of data to be specified in the tag.

Moreover, the “image” tag is here also associated with a content type attribute “contentType” which makes it possible to define the nature of the data to be incorporated.

This attribute “contentType” may take different values of the MIME field.

By way of example, an extract from an XML schema for declaring such a tag of “opaque” type associated with these two attributes may be written as follows:

// schema of a request for image processing request

<xs:element name=“rotate”/>

<xs:complexType>

<xs:element name=“image” type=“xs:opaque”>

<xs:attribute name=“contentType” type=“xs:mimeType”/>

<xs:attribute name=“contentLength” type=“xs:integer”/>

</xs:element>

<xs:element name=“angle” type=“xs:integer”/>

</xs:complexType>

</xs:element>

Thus, on coming back to the request in XML and to the incorporation of the set of binary data, after writing the “image” tag, the length attribute “contentLength” is added in an adding step S14 then, in an association step S15, a value equal to the length n acquired at the acquisition step S10 is added to that length attribute.

The content type attribute “contentType” is then proceeded with in the same manner.

This content type attribute is added to the request in XML in an adding step S16, then an association step S17 makes it possible to associate the value determined at step S11, and equal here to “image/JPEG”, with that content type attribute.

This “image” tag and its attributes thus written, a closing bracket>is written in a conventional manner in a writing step S18.

Next, a writing step S19 enables the set of binary data to be incorporated verbatim in the XML document, directly after the opening tag already written.

The set of binary data can thus be incorporated directly in the request for remote execution in XML, without modification of the file and prior processing of the binary data.

After this set of data, a closing tag of predefined “opaque” type is introduced, which comprises successively a step S20 of writing a bracket followed by a slash </, a step S21 of writing the name of the “image” tag and a step S22 of writing a closing bracket >.

This incorporating method thus allows the introduction, into the interior of a request for remote execution in XML language, of a set of binary data verbatim, without modification of this file.

An example of such a request, for the rotation of an image through 90°, is given below:

// corresponding request for image processing request

<rotate>

<image>

contentType=“image/jpeg”
contentLength=“256”>binary JPEG image here </image>

<angle>90</angle>

</rotate>

This incorporation directly in the XML document is made possible by the use of the “image” tag of predefined “opaque” type.

With reference to FIGS. 2 and 3, a description will now be given of a method of processing such a set of binary data incorporated in an XML document.

When a request for remote execution of a function written in XML is involved, the method of incorporating the set of binary data is performed at the client station, so as to introduce the set of binary data into the request.

This request is next transmitted, with the set of binary data incorporated, to the server station of a communication network which must process this set of data, and in particular execute a function on the set of data.

Here, it is considered for example that the client station requests the remote execution of a rotation of a digital image through an angle of 90°.

At the time of the processing procedure on a server station of the network, a step S30 of receiving the XML document is first of all implemented.

To the extent that the XML document is associated with an XML schema, an obtaining step S30 enables the station to obtain the corresponding XML schema.

A step S32 of actual analysis of the document is then implemented in order to read the XML document.

This analysis of the document is illustrated in detail in FIG. 3.

Generally, and as is well known by the person skilled in the art, this analysis of the XML document is performed through the reading of the document, tag by tag, identifying each tag, its type, its possible attributes and the value of its data.

This recursive method thus comprises a step S320 of reading a first tag.

A test S321 makes it possible to verify if this tag is of the predefined “opaque” type.

When such a tag of predefined type is detected, a reading step S322 enables the value of its attributes to be read.

Here, and in accordance with the invention, this reading step S322 enables the value of the content length attribute to be read.

Furthermore, in this embodiment, the reading step also enables the value of the content type attribute to be read.

These values here are respectively “n” and “image/jpeg”.

An automatic identification step S323 next enables the identification, from the value n of content length, of the set of binary data following the tag and of length equal to that read value n.

In practice, it is possible to automatically identify the next n bytes after the closing bracket> marking the end of the opening tag of predefined opaque type.

Thus, by virtue of this particular tag, indicating the presence of a particular set of data to the parser, it is possible to identify automatically this set of data thanks to its length n memorized in the length attribute.

Here, this automatic identification step S323 is followed by a memorization step S324 making it possible to memorize at the same time the name of the “image” tag, the content type “image/jpeg” and the bytes identified, that is to say the binary data contained in the XML document.

The memorization of these data is illustrated by way of example in FIG. 4.

This memorization step S324 enables the binary data thus memorized to be processed later.

In the particular case where the parser is also capable of processing these binary data, for example on displaying an image in an XML document, this display may be performed as soon as the binary data have been identified by the parser.

It is observed furthermore that the content length n is useful for the parser for automatically identifying the set of data incorporated in the XML document.

On the other hand, the content type is not directly used here by the parser, but is memorized at step S324 in order to be used on the processing of data by the application itself.

The analyzing procedure is then continued for all the tags of the document, and more particularly, a reading step S325 enables the following tag to be identified.

In a test step S326 it is verified that this really is a closing tag.

If not, an error message is generated at a step S327 and the analyzing process is interrupted.

However, if a closing tag is actually present, it is verified in a test step S328 that this is the last tag. If not, the following tag is read in a reading step S329, then the test step S321 is reiterated in order to determine if this tag is of “opaque” type. If so, steps S322 to S329 are reiterated.

If not, the analysis of the document continues in a typical manner by verifying at a test step S330 it this is a tag of simple type, that is to say that the tag does not comprises any sub-part, also known as child tag in XML language.

If such is actually the case, a step S331 enables the value of the data associated with this tag to be read up to the start of the closing tag, identified by the symbols </.

A memorization step S332 also makes it possible to memorize the name of the tag, its type and its value thus read.

If at the end of the test step S330, the type of tag in course is not simple but of complex type, i.e. comprising child tags, the process of analysis of the document is implemented in the same manner for the sub-part included in this current tag.

This analyzing step S32 is identical to the analyzing procedure described with reference to FIG. 3.

In particular, the identification of a tag of opaque type and of a set of binary data incorporated after that tag of predefined type can be performed at any hierarchical level of the XML document.

When, at the end of step S328, all the tags have been analyzed, the analyzing procedure of the document is terminated and the procedure continues, as illustrated in FIG. 2, with a step S33 of processing the binary data identified and memorized at the memorization step S324.

In this example, the processing step S33 is a step of executing the function on the set of binary data identified.

The calling of the function by the server station and the utilization of the arguments associated with this function are implemented with respect to this memorized set of binary data in known manner.

Reference can advantageously be made to the patent application EP 1 065 592 for the remote execution of such a function.

By way of example, this function corresponds to a rotation through 90°0 of an image represented by the set of binary data.

According to the invention, the method of incorporating and processing a set of binary data advantageously enables the incorporation of a binary data file verbatim in an XML document and to identify it in the XML document with a view to its later processing.

This method is in particular very advantageous for transmitting a set of binary data in a request for remote execution between two computers in a communication network.

The method of incorporating these binary data may advantageously be implemented directly in a mobile telephone or in a Personal Digital Assistant (PDA).

The device for analysis of an XML document and for processing of the data identified may typically be incorporated into a server station of a communication network adapted to communicate with a mobile telephone or a personal digital assistant.

One or other of these computer systems is shown schematically in FIG. 5.

When a device for the incorporation of a set of data is implemented in such a computer system, it comprises in particular means for introducing opening tags and closing tags of opaque type, means for acquiring the length of the set of data, means of associating with the length attribute of the tag an attribute value equal to that acquired length and means for writing the set of data verbatim, directly after the opening tag introduced.

It also comprises means for determining the content type of the set of data and association means for associating with the opening tag a content type attribute having a value equal to the content type determined.

Alternatively, when a device for processing and analysis of a document is incorporated into a computer system as shown in FIG. 5, it comprises means for detecting a tag of “opaque” type and means for reading the value of the length attribute, and possibly for reading the value of a content type attribute.

According to the invention, it also comprises means for the automatic identification of a set of data of length equal to the read value as well as means for memorizing this identified set of data as well as the value of the content type attribute.

Means for processing the set of data identified can be incorporated in the analyzing device, and, for example, means for displaying an image.

Otherwise, means for processing the set of data identified may be distinct from the analyzing device and in particular may comprise a computer application enabling for example the execution of a function on the set of data identified.

As shown in FIG. 5, the incorporating device on the one hand, and the analyzing device on the other hand, may be incorporated in a microprocessor 100, a Read Only Memory or ROM 101 comprising a program for incorporating a set of data or for analyzing documents, and a Random Access Memory or RAM 102, comprising registers adapted to record the variables modified during the execution of the program.

In particular, this Random Access Memory 102 comprises particularly registers for storing the values of the attributes “contentLength” and “contentType” as well as the “opaque” type.

The microprocessor 100 is integrated into a computer 10 which may be connected to different peripheral devices.

The computer 10 comprises a communication interface 110 connected to the communication network 1 so as to receive or transmit documents such as computer requests.

The computer 10 further comprises means for storing documents, such as a hard disk 106, or is adapted to cooperate, by means of a disk reader 107 (diskettes, compact disks or computer cards), with removable means for storing documents, such as disks 700.

These fixed or removable storage means may further comprise the code of the incorporating or analyzing and processing method according to the invention, which, once read by the microprocessor 100, will be stored on the hard disk 106.

By way of variant form, the program enabling the incorporating or analyzing and processing device to implement the invention could be stored in the Read Only Memory 101.

In a second variant form, the program could be received via the communication network 1 in order to be stored as previously described.

The computer 10 also has a screen 10 able to serve as an interface with a user with the aid of a keyboard 104 or mouse 105 or any other means of displaying the data of the XML document after analysis and for example the digital images also incorporated in the XML document.

The Central Processing Unit (CPU) 100 will execute the instructions relating to the implementation of the invention. On powering up, the programs and methods relating to the invention stored in a non-volatile memory, for example the Read Only Memory 101, are transferred into the Random Access Memory 102 which will then contain the executable code of the invention as well as the variables necessary for the implementation of the invention.

The communication bus 112 affords communication between the different sub-elements of the computer 10 or linked to it. The representation of the bus 112 is non-limiting and in particular the microprocessor 100 is liable to communicate instructions to any sub-element or via another sub-element.

Of course, numerous modifications may be made to the embodiment previously described without departing from the scope of the invention.

In particular, the data file incorporated verbatim in the XML document may be a compressed ZIP file.

It is also possible to incorporate a second XML document in a main XML document, the analysis and reading of which is not desired at the time of the analysis of the main XML document.

1. A method of analyzing a document represented in a markup language, characterized in that it comprises the following steps:
detecting (S321) a tag of predefined type, said tag being associated with at least one content length attribute;
reading (S322) the value (n) of said content length attribute; and
automatically identifying (S323) a set of data following said tag and of length equal to said read value (n).

2. An analyzing method as claimed in claim 1, characterized in that it further comprises a step (S324) of memorizing said set of data.

3. An analyzing method as claimed in claim 1, characterized in that, the tag being associated in addition with a content type attribute, the analyzing method comprises the following steps:
reading (S322) the value of said content type attribute; and
memorizing (S324) said set of data and the value of said content type attribute.

4. A method of incorporating a set of data in a document represented in a markup language, characterized in that it comprises the following steps:
introducing (S12-S18) an opening tag of predefined type, comprising at least one content length attribute;
acquiring (S10) the length (n) of said set of data;
associating (S16) an attribute value equal to said acquired length (n) with said content length attribute;
writing (S19) said set of data verbatim in the document, after said opening tag of predefined type; and
introducing (S20-S22) a closing tag of said predefined type.

5. An incorporating method according to claim 4 characterized in that it further comprises the following steps:
determining (S11) the content type of said set of data, chosen from a predefined group (G) of content types; and
associating (S17) said opening tag of predefined type with a content type attribute and an attribute value equal to said determined content type.

6. A method of processing a set of data incorporated in a document represented in a markup language, characterized in that it comprises the following steps:
analyzing (S32) the document by a analyzing method according to one of claims 1 to 3; and
processing (S33) the set of data in the form as identified.

7. A processing method according to claim 6, the set of data being a set of binary data representing a digital image, characterized in that it comprises a step of displaying (S33) the image at the completion of the processing of the set of binary data identified.

8. A processing method according to claim 6, the document represented in a markup language being a request for the remote execution of a function on said set of data, characterized in that it comprises a step (S33) of executing the function on a set of data identified.

9. A device for analyzing a document represented in a markup language, characterized in that it comprises:
means (100, 101, 102) for detecting a tag of predefined type, said tag being associated with at least one content length attribute;
means (100, 101, 102) for reading the value (n) of said content length attribute; and
means (100, 101, 102) for automatically identifying a set of data following said tag and of length equal to the value read (n).

10. Analyzing device according to claim 9, characterized in that it comprises means (100, 101, 102) for the memorization of said set of data.

11. Analyzing device according to claim 9, characterized in that, said tag being also associated with a content type attribute, the reading means are adapted to read the value of said content type attribute; and in that it comprises means (100, 101, 102) for memorization of said set of data and of the value of said content type attribute.

12. A device for incorporating a set of data in a document represented in a markup language, characterized in that it comprises:
means (100, 101, 102) for introducing an opening tag of predefined type comprising at least one content length attribute;
means (100, 101, 102) for acquiring the length (n) of said set of data;
means (100, 101, 102) for associating an attribute value equal to said acquired length (n) with said content length attribute;
means (100, 101, 102) for writing said set of data verbatim in the document, after said opening tag of predefined type; and
means (100, 101, 102) for introducing a closing tag of said predefined type.

13. An incorporating device according to claim 12, characterized in that it further comprises means (100, 101, 102) for determining the content type of said set of data, chosen from a predefined group of content types; and in that the association means are adapted to associate a content type attribute and an attribute value equal to said determined content type with said opening tag of predetermined type.

14. A device for processing a set of data incorporated in a document represented in a markup language, characterized in that it comprises an analyzing device (100, 101, 102) according to claim 9 and means for processing a set of data identified by the analyzing device.

15. A processing device according to claim 14, characterized in that it comprises means for displaying an image.

16. A processing device according to claim 14, characterized in that it comprises means (100, 101, 102) for the execution of a function on a set of data identified after analysis of a request for remote execution of a function represented in a markup language.

17. A mobile telephone, characterized in that it comprises an analyzing device according to claim 9.

18. A Personal Digital Assistant, characterized in that it comprises an analyzing device according to claim 9.

19. A computer system, characterized in that it comprises an analyzing device according to claim 9.

20. A mobile telephone, characterized in that it comprises an incorporating device according to claim 12.

21. A Personal Digital Assistant, characterized in that it comprises an incorporating device according to claim 12.

22. A computer system, characterized in that it comprises an incorporating device according to claim 12.

23. A mobile telephone, characterized in that it comprises a processing device according to claim 14.

24. A Personal Digital Assistant, characterized in that it comprises a processing device according to claim 14.

25. A computer system, characterized in that it comprises a processing device according to claim 14.

26. An information carrier, possibility partially or wholly removable, readable by a computer system, characterized in that it contains instructions of a computer program adapted to implement an analyzing method according to claim 1 when this program is loaded and run by a computer system.

27. An information carrier, possibility partially or wholly removable, readable by a computer system, characterized in that it contains instructions of a computer program adapted to implement an incorporating method according to claim 4 when this program is loaded and run by a computer system.

28. An information carrier, possibility partially or wholly removable, and readable by a computer system, characterized in that it contains instructions of a computer program adapted to implement a processing method according to claim 6 when this program is loaded and run by a computer system.

29. A computer program stored on an information carrier, said program comprising instructions adapted to implement an analyzing method according to claim 1, when it is loaded and run by a computer system.

30. A computer program stored on an information carrier, said program comprising instructions adapted to implement an incorporating method according to claim 4, when it is loaded and run by a computer system.

31. A computer program stored on an information carrier, said program comprising instructions adapted to implement a processing method according to claim 6, when it is loaded and run by a computer system.

32. A computer document represented in a markup language comprising a tag of predefined type, said tag being associated with at least one content length attribute.

33. A computer document according to claim 32, wherein said tag is associated with a content type attribute.
